(19) United States
(12) Patent Application Publication
(10) Pub. No.: US 2019/0110213 A1
(43) Pub. Date: Apr. 11, 2019

(54) SYSTEMS AND METHOD FOR MANAGEMENT OF COMPUTING NODES

(71) Applicant: Ent. Services Development Corporation LP, Houston, TX (US)

(72) Inventors: Jonathan GIBSON, Austin, TX (US); Joseph MILLER, Boulder, CO (US); Clifford A. WILKE, Herndon, VA (US); Scott A. GAYDOS, Herndon, VA (US)

(21) Appl. No.: 16/212,111

(22) Filed: Dec. 6, 2018

Related U.S. Application Data
(63) Continuation of application No. 15/306,727, filed on Oct. 25, 2016, now abandoned.

(51) Int. Cl. H04W 24/02; G06F 1/16; H04W 84/12; G06F 9/50; G06F 9/00; H04W 88/08

(52) U.S. Cl. CPC H04W 24/02; G06F 1/163; H04W 84/12; G06F 2209/509; G06F 9/00; H04W 88/08; G06F 9/5066

(57) ABSTRACT

In examples provided herein, upon receiving notification of a computational task requested by a package to provide an experience to a user, a remote node management engine identifies computing nodes for performing the computational task and determining available processing resources for each computing node, where a computing node resides at networked wearable devices associated with the user. The remote node management engine further selects one of the computing nodes as a primary controller to distribute portions of the computational task to one or more of the other computing nodes and receive results from performance of the portions of the computational task by the other computing nodes, and provides to the selected computing node information about available processing resources at each computing node.

### CLAIM FOR PRIORITY

This application is a Continuation of U.S. application Ser. No. 15/306,727, filed on Oct. 25, 2016, which is a national stage filing under 35 U.S.C. § 371 of PCT application number PCT/US2014/057645, having an international filing date of Sep. 26, 2014, which are all incorporated herein by reference.

### BACKGROUND

In many arenas, disparate tools can be used to achieve desired goals. The desired goals may be achieved under changing conditions by the disparate tools.

### BRIEF DESCRIPTION OF THE DRAWINGS

The accompanying drawings illustrate various examples of the principles described below. The examples and drawings are illustrative rather than limiting.

FIG. 1 depicts an example environment in which a context-aware platform that performs computing node functions may be implemented.

FIG. 2A depicts a block diagram of example components of a remote node management engine.

FIG. 2B depicts a block diagram depicting an example memory resource and an example processing resource for a remote node management engine.

FIG. 3A depicts a block diagram of example components of a computing node, such as a networked wearable device or access point.

FIG. 3B depicts a block diagram depicting an example memory resource and an example processing resource for a computing node.

FIG. 4 depicts a block diagram of an example context-aware platform.

FIG. 5 depicts a flow diagram illustrating an example process of identifying and selecting a networked wearable device associated with a user to act as a primary controller to coordinate performance of a computational task for a package for a user experience.

FIG. 6 depicts a flow diagram illustrating an example process of determining a backup controller for a malfunctioning primary controller.

FIG. 7 depicts a flow diagram illustrating an example process of determining suitable access points for performing a computational task for a package.

FIGS. 8A and 8B depict a flow diagram illustrating an example process of a primary controller distributing portions of a computational task to computing nodes.

FIG. 9 depicts an example system including a processor and nontransitory computer readable medium of a remote node management engine.

FIG. 10 depicts an example system including a processor and nontransitory computer readable medium of a computing node.

### DETAILED DESCRIPTION

As technology becomes increasingly prevalent, it can be helpful to leverage technology to integrate multiple devices, in real-time, in a seamless environment that brings context to information from varied sources without requiring explicit input. Various examples described below provide for a context-aware platform (CAP) that supports remote management of one or more computing nodes, hosted at a networked wearable device (NWD) associated with a user or other device in close proximity to a user's networked devices. The user can be a person, an organization, or a machine, such as a robot. The computing nodes provide computational resources that can allow for faster responses to computationally intense tasks performed in support of providing a seamless experience to the user, as compared to processing performed in a centralized computation model, such as cloud computation, which can introduce latency into the computation process. As used herein, “CAP experience” and “experience” are used interchangeably and intended to mean the interpretation of multiple elements of context in the right order and in real-time to provide information to a user in a seamless, integrated, and holistic fashion. In some examples, an experience or CAP experience can be provided by executing instructions on a processing resource at a computing node. Further, an “object” can include anything that is visible or tangible, for example, a machine, a device, and/or a substance.

The CAP experience is created through the interpretation of one or more packages. Packages can be atomic components that execute functions related to devices or integrations to other systems. As used herein, “package” is intended to mean components that capture individual elements of context in a given situation. In some examples, the execution of packages provides an experience. For example, a package could provide a schedule or a navigation component, and an experience could be provided by executing a schedule package to determine a user's schedule, and subsequently executing a navigation package to guide a user to the location of an event or task on the user's schedule. As another example, another experience could be provided by executing a facial recognition package to identify a face in an image by comparing selected facial features from the image with data in a facial database.

In some examples, the platform includes one or more experiences, each of which correspond to a particular application, such as a user's occupation or a robot's purpose. In addition, the example platform may include a plurality of packages which are accessed by the various experiences. The packages may, in turn, access various information from a user or other resources and may call various services, as described in greater detail below. As a result, the user can be provided with contextual information seamlessly with little or no input from the user. The CAP is an integrated ecosystem that can bring context to information automatically and “in the moment.” For example, CAP can sense, retrieve, and provide information from a plurality of disparate sensors, devices, and/or technologies, in context, and without input from a user.

Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

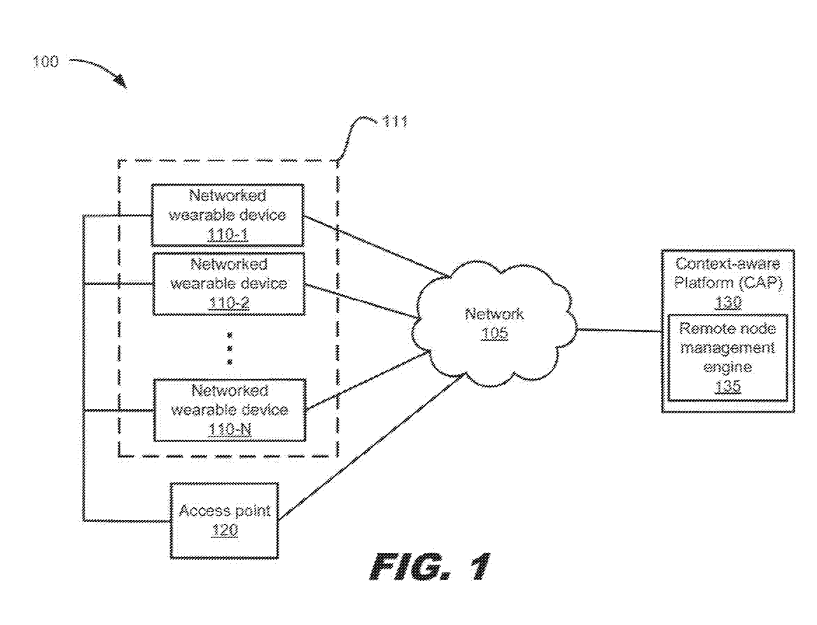

FIG. 1 depicts an example environment in which a context-aware platform (CAP) 130 that includes a remote node management engine 135 for managing computational tasks performed at remote computing nodes may be implemented.

Wearable devices can include any number of portable devices associated with a user of the devices that have a processor and memory and are capable of communicating wirelessly by using a wireless protocol, such as WiFi or Bluetooth. Examples of wearable devices include a smartphone, tablet, laptop, smart watch, electronic key fob, smart glass, and any other device or sensor that can be attached to or worn by a user. When a user's wearable devices are configured to communicate with each other, for example, as indicated by wearable device communication network 111 in FIG. 1, the devices are referred to herein as networked wearable devices (NWDs) 110.

Access point 120 can be a standalone access point device; however, examples are not so limited, and access point 120 can be embedded in a stationary device, for example, a printer, a point of sale device, etc. The access point 120 can include a processor and memory configured to communicate with the device in which it is embedded and to communicate with the CAP 130 and/or networked wearable devices 110 within wireless communication range. While only one access point 120 is shown in the example of FIG. 1 for clarity, multiple access points can be located within wireless communication range of the one or more NWDs associated with a user.

A computing node used for performing a portion of a computational task requested by a package to provide an experience to a user can reside at a NWD 110 associated with that user or at an access point 120 within wireless communication range of the user's NWDs 110. Each computing node includes components, to be described below, that support performing computational tasks for the experience by using the available processing resources of the NWD 110 or access point 120.

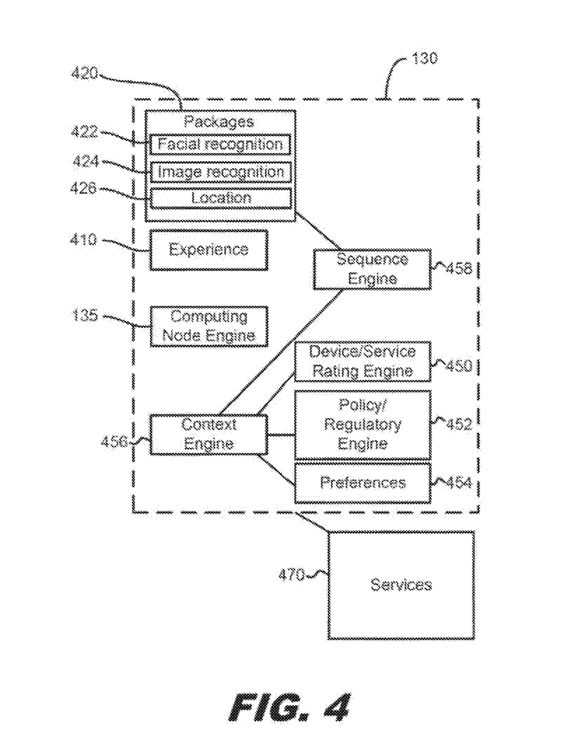

In the example of FIG. 1, the CAP 130 can communicate through a network 105 with one or more of the computing nodes at the NWDs 110 and/or a computing node at the access point 120. The network 105 can be any type of network, such as the Internet, or an intranet. The CAP 130 includes a remote node management engine 135, among other components to be described below with reference to FIG. 4. The remote mode management engine 135 supports the selection and remote management of computing nodes in close proximity to the user to provide faster responses to computational activities intended to support providing an experience to the user. The experience can be user-initiated or automatically performed.

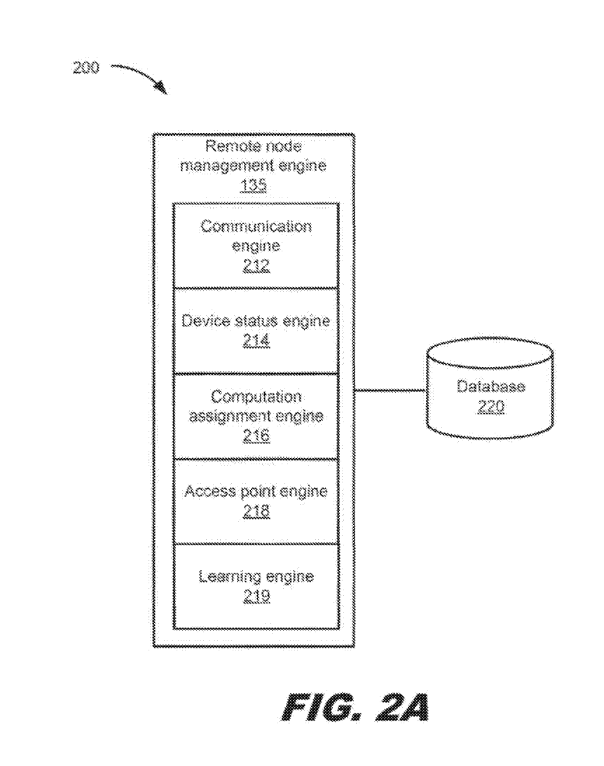

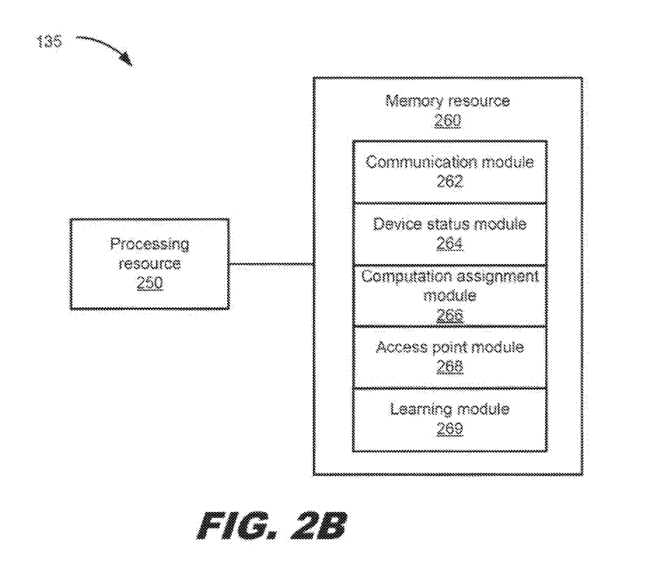

FIG. 2A depicts a block diagram 200 including example components of a remote node management engine 135. The remote node management engine 135 can include a communication engine 212, a device status engine 214, a computation assignment engine 216, an access point engine 218, and a learning engine 219. Each of the engines 212, 214, 216, 218, 219 can access and be in communication with a database 220.

Communication engine 212 may be configured to receive notification of a computational task requested by a package to be performed in conjunction with providing an experience to a user. Further, the communication engine 212 can transmit a request to a computing node at one of the NWDs 110 or access points 120 associated with the user to function as a primary controller to distribute portions of the computational task to one or more other computing nodes. The other computing nodes can reside at one of the other NWDs and/or one or more access points 120 in close proximity to the user. For example, the computing nodes at the NWDs 110 can be used if the user is not near any access points, such as when the user is outside.

Alternatively, if the user is near one or more access points 120, for example, inside an office building or shopping complex, the communication engine 212 can transmit requests directly to the one or more access points to perform respective portions of the computational task. The communication engine 212 can receive results from performance of the portions of the computational task by the computing nodes from the primary controller or, in some implementations, directly from the computing nodes and transmit the results of the computational task to the requesting package.

In some implementations, the communication engine 212 may also be configured to retrieve information and/or metadata used to perform the computational task and to transmit the information and/or metadata to the primary controller and/or one or more of the computing nodes. For example, for a facial recognition computational task, the retrieved information can be a facial database with corresponding identity information for each of the faces in the database.

The device status engine 214 may be configured to register and identify computing nodes at NWDs associated with a user. When a computational task is to be performed to support an experience to be provided to a particular user, the device status engine 214 can determine available processing resources at each NWD 110 associated with the user, and provide to the selected NWD (primary controller) information about available processing resources at each NWD 110.

The access point engine 218 may be configured to register and identify access points. Registration information can include a location identifier, such as global positioning (GPS) coordinates. Upon receiving notification of a computational task requested by a package for providing an experience to a user, the access point engine 218 may identify one or more suitable access points within communication range of the NWDs 110 associated with the user based on the location of the user. The access point engine 218 can communicate with the appropriately located access points to determine available processing resources at the respective access points. Additionally, the access point engine 218 may be configured to provide to the selected NWD (primary controller) information about available processing resources at the access point.

Based upon the determined available processing resources at each NWD 110 and access point 120, the computation assignment engine 216 may be configured to select one of the computing nodes at a selected NWD 110 or access point 120 as a primary controller or backup controller to distribute portions of the computational task to one or more of the other NWDs 110 and/or access points 120 within wireless communication range of the user and receive results from performance of the portions of the computational task. In deciding which computing node to distribute portions of the computational task, the computation assignment engine 216 can take into account availability of processing resources at the computing nodes, as well as availability of storage for performing the computational task in a timely manner. Further, the computation assignment engine 216 receives checkpoint information and heartbeats from the primary controller and/or the backup controller to ensure that the computational task is being performed. In some instances, the computation assignment engine 216 may cancel the computational task or restart the computational task.

The learning engine 219 may be configured to track capabilities of each of the NWDs 110 and access points 120 as a computing node, such as speed with which assigned computational tasks are performed and available memory for use in conjunction with performing the computational tasks. Additionally, the learning engine 219 may be configured to determine from the tracked capabilities of specific NWDs 110 and access points 120 which of the specific NWDs and access points can function as a backup controller for the primary controller, for example, based on training data. Moreover, should the primary controller be unresponsive, for example, because of loss of battery power or a software problem, the learning engine 219 can select a particular one of the specific NWDs or access points as the backup controller to substitute for the primary controller.

Database 220 can store data, such as retrieved information or metadata used to perform a computational task.

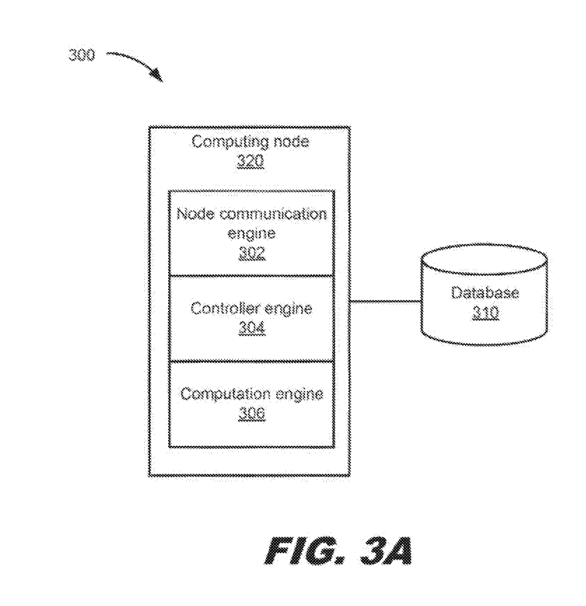

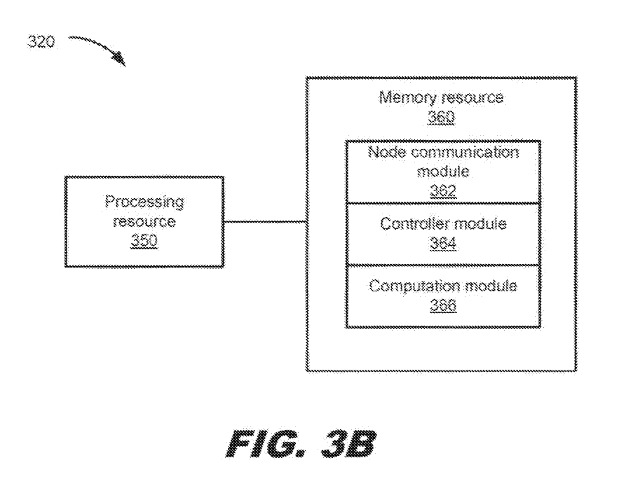

FIG. 3A depicts a block diagram of example components of an example computing node residing at a networked wearable device 110 or access point 120. The computing node can include a node communication engine 302, a controller engine 304, and a computation engine 306. Each of engines 302, 304, 306 can interact with a database 310.

Node communication engine 302 may be configured to receive the portion of the computational task to be performed at the computing node. In some instances, the node communication engine 302 may also receive information and/or metadata to be used to perform the computational task.

If a computing node is selected as the primary controller, or the backup controller, the node communication engine 302 may also be configured to periodically send checkpoint information and a heartbeat, to the remote node management engine 135 of the CAP 130. Receipt of the periodic heartbeat informs the remote node management engine 135 that the primary controller is still functioning and able to perform the duties of the primary controller, namely, selecting one or more computing nodes at the other NWDs and/or access points for performing portions of the computational task, receiving results from the performance of the portions of the computational task, and transmitting the results of the computational task to the requesting package.

Additionally, the node communication engine 302 can be configured to receive the last checkpoint information sent by the primary controller when performing the functions of the backup controller. In case the primary controller fails to function properly, periodic checkpoint information sent by the node communication engine 302 regarding the state or progress of the computational task allows a backup controller to resume coordinating the results of the computational task from the last sent checkpoint.

Further, if the computing node is the primary controller or the backup controller, the node communication engine 302 can receive information about processing resources available at computing nodes at NWDs 110 and/or access points 120 within communication range of the NWDs. This allows the controller engine 304 to determine to which computing nodes portions of the computational task should be assigned.

If the computing node is the primary or backup controller, the controller engine 304 may be configured to assign portions of the computational task to one or more computing nodes at other NWDs 110 and/or access points 120 based on the availability of processing resources at those computing nodes. Otherwise, if the computing node is not acting as the primary or backup controller, the controller engine 304 does not perform any functions.

The computation engine 306 may be configured to use the available processing resources at the local computing node to perform one or more portions of the computational task, or even the entire computational task if processing resources at other NWDs 110 or access points 120 are not readily available at the requested time.

Database 310 can store data, such as retrieved information or metadata used to perform a computational task, or intermediate results obtained while performing the computational task.

The examples of engines shown in FIGS. 2A and 3A are not limiting, as one or more engines described can be combined or be a sub-engine of another engine. Further, the engines shown can be remote from one another in a distributed computing environment, cloud computing environment, etc.

In the above description, various components were described as combinations of hardware and programming. Such components may be implemented in different ways. Referring to FIG. 2B, the programming may be processor executable instructions stored on tangible memory resource 260 and the hardware may include processing resource 250 for executing those instructions. Thus, memory resource 260 can store program instructions that when executed by processing resource 250, implements remote node management engine 135 of FIG. 2A. Similarly, referring to FIG. 3B, the programming may be processor executable instructions stored on tangible memory resource 360 and the hardware may include processing resource 350 for executing those instructions. So memory resource 360 can store program instructions that when executed by processing resource 350 implements the computing node portion of NWD 110 or access point 120 of FIG. 3A.

Memory resource 260 generally represents any number of memory components capable of storing instructions that can be executed by processing resource 250. Similarly, memory resource 360 generally represents any number of memory components capable of storing instructions that can be executed by processing resource 350. Memory resource 260, 360 is non-transitory in the sense that it does not encompass a transitory signal but instead is made up of one or more memory components configured to store the relevant instructions. Memory resource 260, 360 may be implemented in a single device or distributed across devices. Likewise, processing resource 250 represents any number of processors capable of executing instructions stored by memory resource 260, and similarly for processing resource 350 and memory resource 360. Processing resource 250, 350 may be integrated in a single device or distributed across devices. Further, memory resource 260 may be fully or partially integrated in the same device as processing resource 250, or it may be separate but accessible to that device and processing resource 250, and similarly for memory resource 360 and processing resource 350.

In one example, the program instructions can be part of an installation package that when installed can be executed by processing resource 250 to implement remote node management engine 135 or by processing resource 350 to implement the computing node portion of NWD 110 or access point 120. In this case, memory resource 260, 360 may be a portable medium such as a compact disc (CD), digital video disc (DVD), or flash drive or a memory maintained by a server from which the installation package can be downloaded and installed. In another example, the program instructions may be part of an application or applications already installed. Memory resource 260, 360 can include integrated memory, such as a hard drive, solid state drive, or the like.

In the example of FIG. 2B, the executable program instructions stored in memory resource 260 are depicted as communication module 262, device status module 264, computation assignment module 266, access point module 268, and learning module 269. Communication module 262 represents program instructions that when executed cause processing resource 250 to implement communication engine 212. Device status module 264 represents program instructions that when executed cause processing resource 250 to implement device status engine 214. Computation assignment module 266 represents program instructions that when executed cause processing resource 250 to implement computation assignment engine 216. Access point module 268 represents program instructions that when executed cause processing resource 250 to implement access point engine 218. Learning module 269 represents program instructions that when executed cause processing resource 250 to implement learning engine 219.

In the example of FIG. 3B, the executable program instructions stored in memory resource 360 are depicted as node communication module 362, controller module 364, and computation module 366. Communication module 362 represents program instructions that when executed cause processing resource 350 to implement node communication engine 302. Controller module 364 represents program instructions that when executed cause processing resource 350 to implement controller engine 304. Computation module 366 represents program instructions that when executed cause processing resource 350 to implement computation engine 306.

FIG. 4 depicts a block diagram of an example context-aware platform (CAP) 130. The CAP 130 may determine what package among multiple available packages 420 to execute based on information provided by the context engine 456 and the sequence engine 458. In some examples, the context engine 456 can be provided with information from a device/service rating engine 450, a policy/regulatory engine 452, and/or preferences 454. For example, the context engine 456 can determine what package to execute based on a device/service rating engine 450 (e.g., hardware and/or program instructions that can provide a rating for devices and/or services based on whether or not a device can adequately perform the requested function), a policy/regulatory engine 452 (e.g., hardware and/or program instructions that can provide a rating based on policies and/or regulations), preferences 454 (e.g., preferences created by a user), or any combination thereof. In addition, the sequence engine 458 can communicate with the context engine 456 to identify packages 420 to execute, and to determine an order of execution for the packages 420. In some examples, the context engine 456 can obtain information from the device/service rating engine 450, the policy/regulatory engine 452, and/or preferences 454 automatically (e.g., without any input from a user) and can determine what package 420 to execute automatically (e.g., without any input from a user). In addition, the context engine 456 can determine what package 420 to execute based on the sequence engine 458.

For example, based on information provided to the CAP system 130 from the context engine 456, the sequence engine 458, and the device/service rating engine 450, the experience 410 may call a facial recognition package 422 to perform facial recognition on a digital image of a person's face. In some examples, the experience 410 can be initiated by voice and/or gestures received by a NWD 110 which communicates with the CAP system 130 via network 105 (as shown in FIG. 1) to call the facial recognition package 422, as described above. Alternatively, in some examples, the facial recognition package 422 can be automatically called by the experience 410 at a particular time of day, for example, 10:00 pm, the time scheduled for a meeting with a person whose identity should be confirmed by facial recognition. In addition, the facial recognition package 422 can be called upon determination by the experience 410 that a specific action has been completed, for example, after a digital image has been captured by a digital camera on the NWD 110, such as can be found on a smartphone. Thus, in various examples, the facial recognition package 422 can be called by the experience 410 without any input from the user. Similarly, other packages 420 that may need the performance of computationally intensive tasks can be called by the experience 410 without any input from the user.

Additionally, as facial recognition is a processing intensive task, remote node management engine 135 can select a computing node at one of the NWDs 110 or access points 120 as the primary controller for distributing portions of the facial recognition task to other computing nodes, such as at one or more of the NWDs 110 and/or one or more access points 120 in close proximity to the NWDs of the user.

When facial recognition package 422 is executed, it triggers the remote node management engine 135 to call the services 470 to retrieve the facial recognition information and/or metadata. The facial recognition information and/or metadata is transmitted from the remote node management engine 135 via network 105 to the primary controller selected by the remote node management engine 135. The primary controller subsequently transmits the information and/or metadata to the other computing nodes that are assigned a portion of the facial recognition task. Alternatively, the primary controller can retrieve the facial recognition information and/or metadata from the services 470. As a result, the processing resources of multiple NWDs and access points are made available to increase the speed at which the facial recognition task is performed. Moreover, by selecting computing nodes from the NWDs 110 associated with the user to whom the experience 410 will be provided and access points 120 within close proximity of the NWDs 110, for example, within wireless communication range, quicker responses to the computationally intense task is obtained because latency in the process is minimized. In contrast, for example, in a centralized computation model in the cloud, the latency in the process can significantly delay the computations.

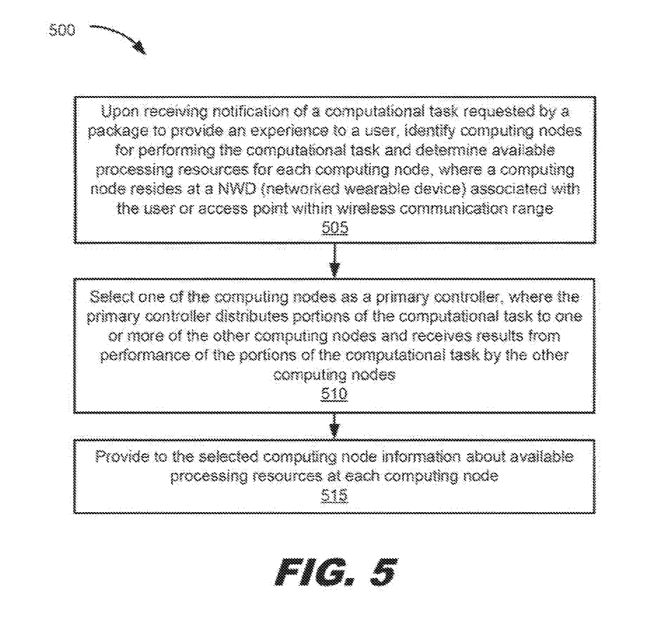

Performing the facial recognition task for the facial recognition package 422 is one example in which one or more local computing nodes can be used to perform the processing for the task for a package. Any type of package can request performance of a task at one or more computing nodes. For example, an image recognition package 424 can trigger the remote node management engine 135 to identify computing nodes for performing an image recognition task for a digital image. As another example, a location package 426 can trigger the remote node management engine 135 to identify computing nodes for performing a task for searching a database to identify the address of a person. These examples of packages are non-limiting. FIG. 5 depicts a flow diagram illustrating an example process 500 of identifying and selecting a computing node to act as a primary controller or backup controller to coordinate performance of a computational task for a package to provide a user experience, where the computational task is performed by computing nodes residing at NWDs associated with the user. The primary or backup controller can be a computing node residing at a NWD associated with the user or at an access point embedded in a printer, point of sale device, or other computational device.

At block 505, upon receiving notification of a computational task requested by a package to provide an experience to a user, the remote node management engine identifies computing nodes for performing the computational task and determines available processing resources for each computing node, where the computing node resides at a NWD associated with the user or access point within wireless communication range.

Then at block 510, the remote node management engine selects one of the computing nodes as a primary controller, where the primary controller distributes portions of the computational task to one or more of the other computing nodes and receives results from performance of the portions of the computational task by the other computing nodes.

At block 515, the remote node management engine provides to the selected computing node information about available processing resources at each computing node.

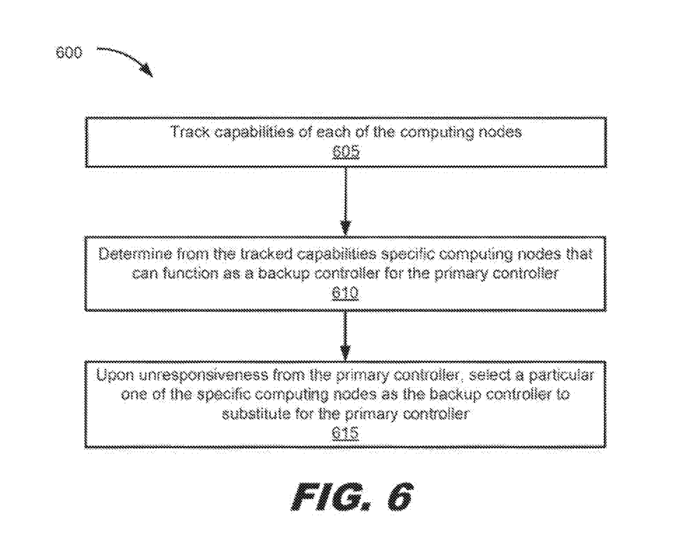

FIG. 6 depicts a flow diagram illustrating an example process 600 of determining a backup controller for a malfunctioning primary controller.

At block 605, the remote node management engine tracks capabilities of each of the computing nodes. Then at block 610, the remote node management engine determines from the tracked capabilities specific computing nodes that can function as a backup controller for the primary controller.

At block 615, the remote node management engine, upon unresponsiveness from the primary controller, selects a particular one of the specific computing nodes as the backup controller to substitute for the primary controller. Unresponsiveness can be characterized as not receiving a predetermined number of consecutive heartbeat signals from the primary controller. The selected backup controller can continue with coordinating the computational task from the last checkpoint successfully provided by the primary controller.

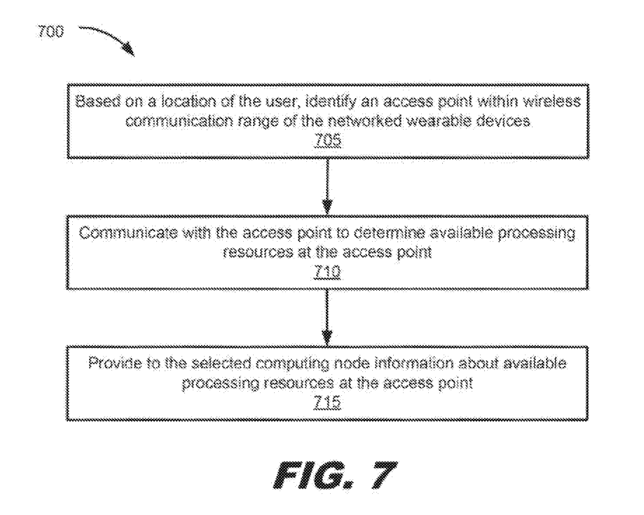

FIG. 7 depicts a flow diagram illustrating an example process 700 of determining suitable access points for performing computational tasks for a package. In this implementation, one or more access points can be selected to perform portions of the computational task.

At block 705, the remote node management engine identifies an access point within wireless communication range of the NWDs, based on a location of the user. Next, at block 710, the remote node management engine communicates with the access point to determine available processing resources at the access point.

At block 715, the remote node management engine provides to the selected computing node acting as the primary controller information about available processing resources at the access point, where the primary controller further distributes a different portion of the computational task to the access point.

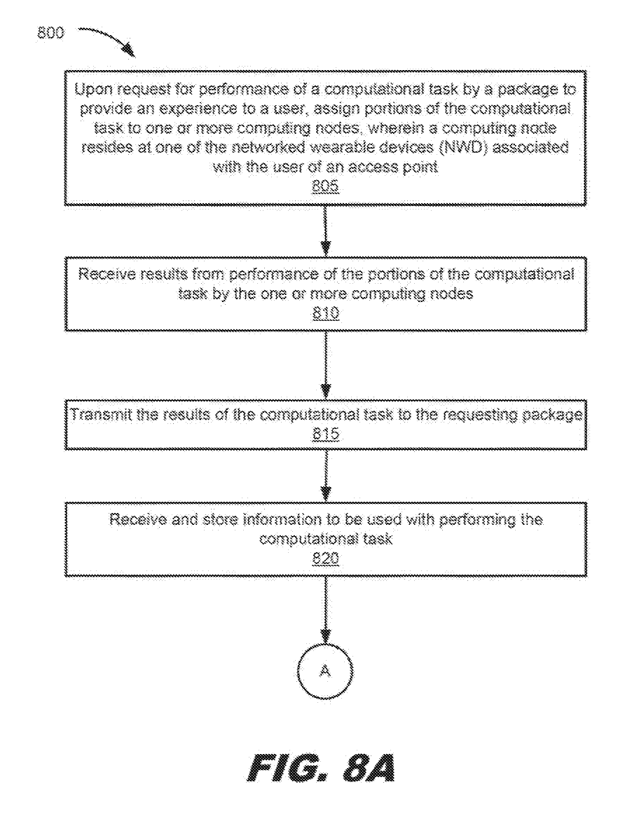

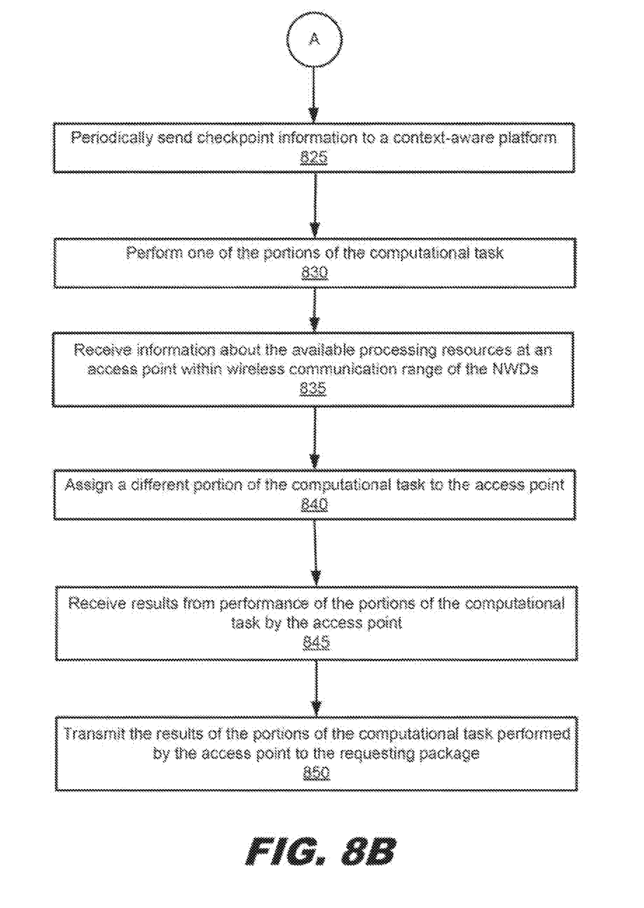

FIGS. 8A and 8B depict a flow diagram illustrating an example process 800 of a primary controller distributing portions of a computational task to computing nodes.

At block 805, upon request for performance of a computational task by a package to provide an experience to a user, a NWD acting as the primary controller or the backup controller, assigns portions of the computational task to one or more computing nodes, where each computing node resides at one of the NWDs associated with the user or at an access point embedded in a printer, point of sale device, or other computational device. An access point can also perform the functions of the primary controller or backup controller.

At block 810, the primary controller or the backup controller receives results from performance of the portions of the computational task by the one or more computing nodes. Then at block 815, the primary controller or the backup controller transmits the results of the computational task to the requesting package.

At block 820, the primary controller or the backup controller receives and stores information to be used for performing the computational task.

Next, at block 825, the primary controller or the backup controller periodically sends checkpoint information to a context-aware platform.

Then at block 830, the primary controller can perform one of the portions of the computational task.

At block 835, the primary controller receives information about the available processing resources at an access point within wireless communication range of the NWDs, and at block 840, the primary controller assigns a different portion of the computational task to the access point.

At block 845, the primary controller receives results from performance of the portions of the computational task by the access point, and at block 850, the primary controller transmits the results of the portions of the computational task performed by the access point to the requesting package.

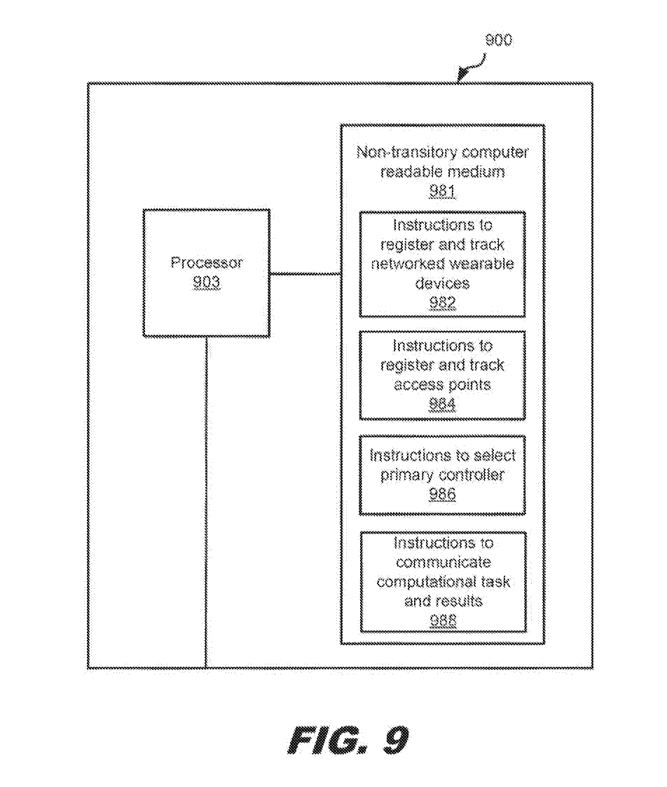

FIG. 9 illustrates an example system 900 including a processor 903 and non-transitory computer readable medium 981 according to the present disclosure. For example, the system 900 can be an implementation of an example system such as remote node management engine 135 of FIG. 2A.

The processor 903 can be configured to execute instructions stored on the non-transitory computer readable medium 981. For example, the non-transitory computer readable medium 981 can be any type of volatile or non-volatile memory or storage, such as random access memory (RAM), flash memory, or a hard disk. When executed, the instructions can cause the processor 903 to perform a method of selecting a computing node as a primary controller of other computing nodes for performing a computational task requested by a package.

The example medium 981 can store instructions executable by the processor 903 to perform remote NWD management. For example, the processor 903 can execute instructions 982 to register and track NWDs associated with a user and the available processing resources at the NWDs.

The example medium 981 can further store instructions 984. The instructions 984 can be executable to register and track access points capable of performing a computational task requested by a package and the available processing resources at the access points.

The example medium 981 can further store instructions 986. The instructions 986 can be executable to select one of the computing nodes as a primary controller of other computing nodes that can perform portions of the computational task. In addition, the processor 903 can execute instructions 986 to perform block 510 of the method of FIG. 5.

The example medium 981 can further store instructions 988. The instructions 988 can be executable to communicate the computational task, information about available processing resources at each computing node, and any needed information for performing the computational task to the computing node selected as the primary controller. In addition, the processor 903 can execute instructions 988 to perform block 515 of the method of FIG. 5.

In some implementations, the instructions 988 can be executable to communicate the computational task and any needed information for performing the computational task directly to one or more of the computing nodes, receive the results, and transmit the results to the package.

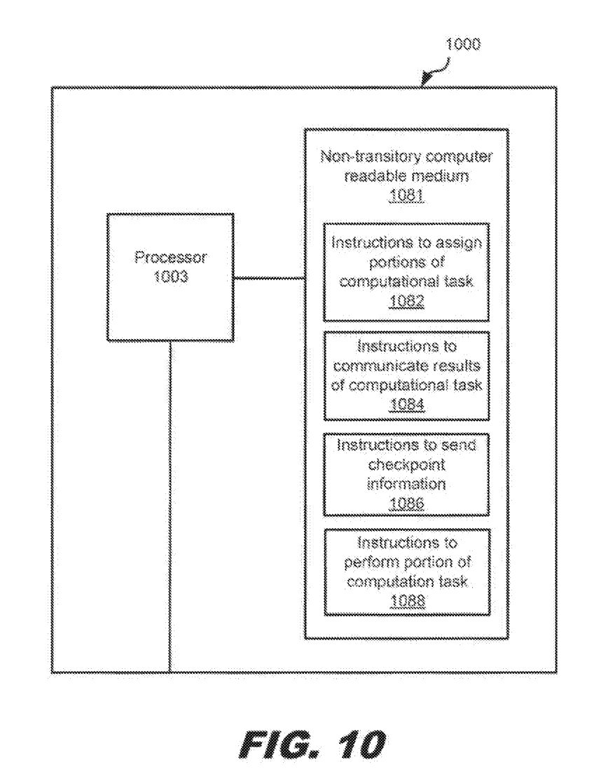

FIG. 10 illustrates an example system 1000 including a processor 1003 and non-transitory computer readable medium 1081 according to the present disclosure. For example, the system 1000 can be an implementation of an example system such as a computing node 320 of FIG. 3A residing at a NWD 110 or access point 120.

The processor 1003 can be configured to execute instructions stored on the non-transitory computer readable medium 1081. For example, the non-transitory computer readable medium 1081 can be any type of volatile or non-volatile memory or storage, such as random access memory (RAM), flash memory, or a hard disk. When executed, the instructions can cause the processor 1003 to perform a method of.

The example medium 1081 can store instructions executable by the processor 1003 to distribute portions of a computational task to computing nodes, such as the method described with respect to FIGS. 8A and 8B. For example, the processor 1003 can execute instructions 1082 to assign portions of computational tasks to one or more NWDs and/or access points. In addition, the processor 1003 can execute instructions 1082 to perform blocks 805 and 840 of the method of FIGS. 8A and 8B.

The example medium 1081 can further store instructions 1084. The instructions 1084 can be executable to communicate with the one or more NWDs and/or access points to receive results of performing the portions of the computational tasks and transmit the results of the computational task to the requesting package. Additionally, the processor 1003 can execute instructions 1084 to perform blocks 810, 815, 845, and 850 of the method of FIGS. 8A and 8B.

The example medium 1081 can further store instructions 1086. The instructions 1086 can be executable to send checkpoint information to the remote node management engine. The checkpoint information can include heartbeats and checkpoints in the performance of the computational task by the assigned computing nodes. In addition, the processor 1003 can execute instructions 1086 to perform block 825 of the method of FIG. 8B.

The example medium 1081 can further store instructions 1088. The instructions 1088 can be executable to perform a portion of the computational task in addition to, or instead of, assigning portions of the computational task to other computing nodes. In addition, the processor 1003 can execute instructions 1088 to perform block 830 of the method of FIG. 8B.

Not all of the steps, features, or instructions presented above are used in each implementation of the presented techniques.

What is claimed is:

1. A system comprising:
at least one processor; and
a memory storing instructions that, when executed by the at least one processor, cause the system to perform:
receiving a notification of a computational task requested by a package to provide an experience to a user;
identifying one or more access points within wireless communication range of networked wearable devices (NWDs) associated with the user;
determining an availability of processing resources at the one or more access points;
identifying available processing resources at the NWDs;
selecting one or more access points to perform portions of the computational task;
selecting one or more of the NWDs to perform different portions of the computational task;
receiving results from performance of the portions of the computational task by the selected access points; and
transmitting the results to the package.

2. The system of claim 1, wherein the instructions, when executed by the at least one processor, further cause the system to perform:
retrieving information to be used for performing the computational task; and
transmitting the information to the selected NWDs and access points.

3. The system of claim 1, wherein the access point is embedded in at least one of: a printer or a point of sale device.

4. A computer-implemented method comprising:
identifying, by a computing system, upon receiving a notification of a computational task requested by a package to provide an experience to a user, one or more computing nodes for performing the computational task and determining available processing resources for each computing node, wherein a computing node resides at a networked wearable device (NWD) associated with the user;
selecting, by the computing system, one of the computing nodes as a primary controller; and
providing, by the computing system, to the selected computing node, information about available processing resources at each computing node,
wherein the primary controller distributes portions of the computational task to one or more of the other computing nodes and receives results from performance of the portions of the computational task by the other computing nodes.

5. The computer-implemented method of claim 4, further comprising:
registering, by the computing system, each of the NWDs, wherein registration information includes an identification of a specific associated user.

6. The computer-implemented method of claim 4, further comprising:
identifying, by the computing system, based on a location of the user, an access point within wireless communication range of the NWDs;
communicating, by the computing system, with the access point to determine available processing resources at the access point; and
providing, by the computing system, to the selected computing node, information about available processing resources at the access point,
wherein the primary controller further distributes a different portion of the computational task to the access point.

7. The computer-implemented method of claim 4, wherein the access point is embedded in at least one of: a printer and a point of sale device.

8. The computer-implemented method of claim 4, further comprising:
tracking, by the computing system, capabilities of each of the computing nodes; and
determining, by the computing system, from the tracked capabilities, specific computing nodes that can function as a backup controller for the primary controller.

9. The computer-implemented method of claim 8, further comprising:
selecting, by the computing system, upon unresponsiveness from the primary controller, a particular one of the specific computing nodes as the backup controller to substitute for the primary controller.

10. A non-transitory computer readable medium storing instructions that, when executed by at least one processor of a computing system, cause the computing system to perform a method comprising:
assigning, upon receipt of a request for performance of a computational task by a package to provide an experience to a user, portions of the computational task to one or more computing nodes, wherein each computing node resides at one of networked wearable devices (NWDs) associated with the user;
receiving results from performance of the portions of the computational task by the one or more computing nodes;
transmitting the results of the computational task to the requesting package; and
periodically sending checkpoint information to a context-aware platform.

11. The non-transitory computer readable medium of claim 10, wherein the stored instructions, when executed by the at least one processor of the computing system, further cause the computing system to perform:
receiving and storing information to be used for performing the computational task.

12. The non-transitory computer readable medium of claim 10, wherein the stored instructions, when executed by the at least one processor of the computing system, further cause the computing system to perform:
executing one of the portions of the computational task.

13. The non-transitory computer readable medium of claim 10, wherein the stored instructions, when executed by the at least one processor of the computing system, further cause the computing system to perform:
receiving information about available processing resources at an access point within wireless communication range of the NWDs; and
assigning a different portion of the computational task to the access point.
